(19) United States
(12) Patent Application Publication
(10) Pub. No.: US 2018/0233265 A1
(43) Pub. Date: Aug. 16, 2018

(54) REACTOR HAVING IRON CORE UNIT AND COILS, MOTOR DRIVER, POWER CONDITIONER AND MACHINE

(71) Applicant: FANUC CORPORATION, Yamanashi (JP)

(72) Inventors: Kenichi Tsukada, Yamanashi (JP); Masatomo Shirouzu, Yamanashi (JP)

(73) Assignee: FANUC CORPORATION, Yamanashi (JP)

(21) Appl. No.: 15/895,131

(22) Filed: Feb. 13, 2018

(30) Foreign Application Priority Data
Feb. 16, 2017 (JP) 2017-027152

(51) Int. Cl. H01F 27/02; H01F 27/08; H01F 27/28; H01F 27/24

(52) U.S. Cl. CPC H01F 27/025; H01F 27/24; H01F 27/28; H01F 27/085

(57) ABSTRACT

A reactor includes an outer peripheral iron core, and at least three iron-core coils that contact or are connected to an inner surface of the outer peripheral iron core. Each of the iron-core coils includes iron cores and coils wound onto the iron cores. A space is formed between each of the coils and the outer peripheral iron core.

### BACKGROUND OF THE INVENTION

### 1. Field of the Invention

The present invention relates to a reactor having an iron core unit and coils, a motor driver, a power conditioner and a machine.

### 2. Description of Related Art

In general, reactors have a plurality of iron cores and a plurality of coils wound onto the iron cores. In the reactors, magnetic fluxes leak and pass through the adjacent coils, and thus generate eddy currents in the coils. As a result, there is a problem of an increase in the temperature of the coils.

Therefore, Japanese Unexamined Patent Publication (Kokai) No. 2009-49082 discloses that “a reactor circulation path 64 is connected to the inside of a reactor case 32 for a reactor 30. The reactor case 32 contains cores 34 and coils 36, which constitute the reactor 30, and a coolant 66 circulates through space inside the container.”

### SUMMARY OF THE INVENTION

However, the reactor disclosed in Japanese Unexamined Patent Publication (Kokai) No. 2009-49082 requires a reactor case through which the coolant circulates, thus causing an increase in structure size.

Therefore, it is desired to provide a reactor that can prevent an increase in the temperature of coils without an increase in structure size, and a motor driver, a power conditioner and a machine having such a reactor.

A first aspect of this disclosure provides a reactor that includes an outer peripheral iron core; at least three iron-core coils in contact with an inner surface of the outer peripheral iron core, each of the iron-core coils including iron cores and coils wound onto the iron cores; and spaces formed between each of the coils and the outer peripheral iron core.

According to the first aspect, the space formed between each coil and the outer peripheral iron core enhances the cooling effect and prevents an increase in the temperature of the coils. Furthermore, eliminating the need for providing a reactor case and a coolant cooling device reduces the size and manufacturing cost of the reactor.

The above-described and other objects, features and advantages of the present invention will become more apparent from the following description of preferred embodiments of the present invention along with the accompanying drawings.

### BRIEF DESCRIPTION OF THE DRAWINGS

FIG. 1 is a perspective view of a reactor according to a first embodiment;

FIG. 2 is an end face view of the reactor shown in FIG. 1;

FIG. 3 is a partly enlarged view of the reactor shown in FIG. 2;

FIG. 4 is an end face view of a reactor according to a second embodiment;

FIG. 5A is a perspective view of a reactor according to a third embodiment;

FIG. 5B is another perspective view of the reactor according to the third embodiment;

FIG. 6A is an exploded perspective view of a reactor according to a fourth embodiment;

FIG. 6B is a side view of the reactor according to the fourth embodiment;

FIG. 7A is an exploded perspective view of a reactor according to a fifth embodiment;

FIG. 7B is a side view of the reactor according to the fifth embodiment; and

FIG. 8 is a block diagram of a machine having a reactor.

### DETAILED DESCRIPTION

Embodiments of the present invention will be described below with reference to the drawings. In the drawings, the same reference numerals refer to similar components. For ease of understanding, the drawings are scaled appropriately.

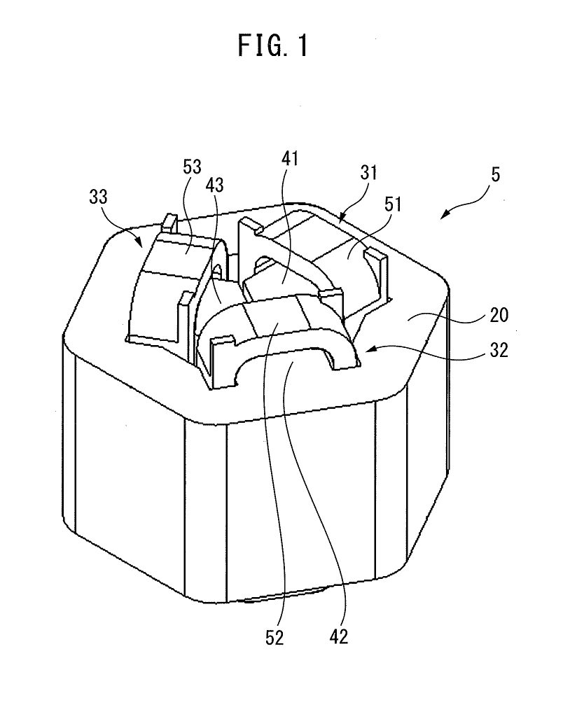

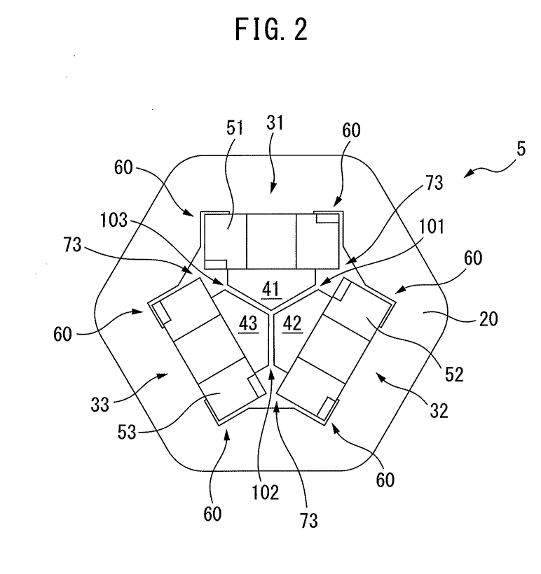

FIG. 1 is a perspective view of a reactor according to a first embodiment. FIG. 2 is an end face view of the reactor shown in FIG. 1. As shown in FIGS. 1 and 2, a reactor 5 includes an outer peripheral iron core 20 having a hexagonal cross-section and at least three iron-core coils 31 to 33 that contact or are connected to an inner surface of the outer peripheral iron core 20. The number of the iron-core coils is preferably an integral multiple of 3, and the reactor 5 can be thereby used as a three-phase reactor. Note that, the outer peripheral iron core 20 may have a round or other polygonal shape.

The iron-core coils 31 to 33 include iron cores 41 to 43 and coils 51 to 53 wound onto the iron cores 41 to 43, respectively. Note that, the outer peripheral iron core 20 and the iron cores 41 to 43 are each made by stacking iron sheets, carbon steel sheets or electromagnetic steel sheets, or made of a pressed powder core.

As is apparent from FIG. 2, the iron cores 41 to 43 have approximately the same dimensions as each other, and are arranged at approximately equal intervals in the circumferential direction of the outer peripheral iron core 20. In FIG. 2, each of the iron cores 41 to 43 contacts the outer peripheral iron core 20 at its radial outer end portion.

Furthermore, the iron cores 41 to 43 converge at the center of the outer peripheral iron core 20 at their radial inner end portions each having an edge angle of approximately 120°. The radial inner end portions of the iron cores 41 to 43 are separated from each other by gaps 101 to 103, which can be magnetically coupled.

In other words, in the first embodiment, the radial inner end portion of the iron core 41 is separated from the radial inner end portions of the adjacent two iron cores 42 and 43 by the gaps 101 and 103, respectively. The same is true for the other iron cores 42 and 43. Note that, the gaps 101 to 103 ideally have the same dimensions, but may not have the same dimensions. In embodiments described later, a description regarding the gaps 101 to 103, the iron-core coils 31 to 33, etc., may be omitted.

As described above, in the first embodiment, the iron-core coils 31 to 33 are disposed inside the outer peripheral iron core 20. In other words, the iron-core coils 31 to 33 are enclosed with the outer peripheral iron core 20. The outer peripheral iron core 20 can reduce leakage of magnetic fluxes generated by the coils 51 to 53 to the outside.

Furthermore, approximately triangular notches 60 are formed in the inner surface of the outer peripheral iron core 20 on both sides of a radial outer end portion of the iron-core coil 31. The notches 60 are formed in a direction from the inner surface toward an outer surface of the outer peripheral iron core 20. Thus, the reactor 5 having the outer peripheral iron core 20 having the notches 60 formed therein has a lighter weight than the prior art.

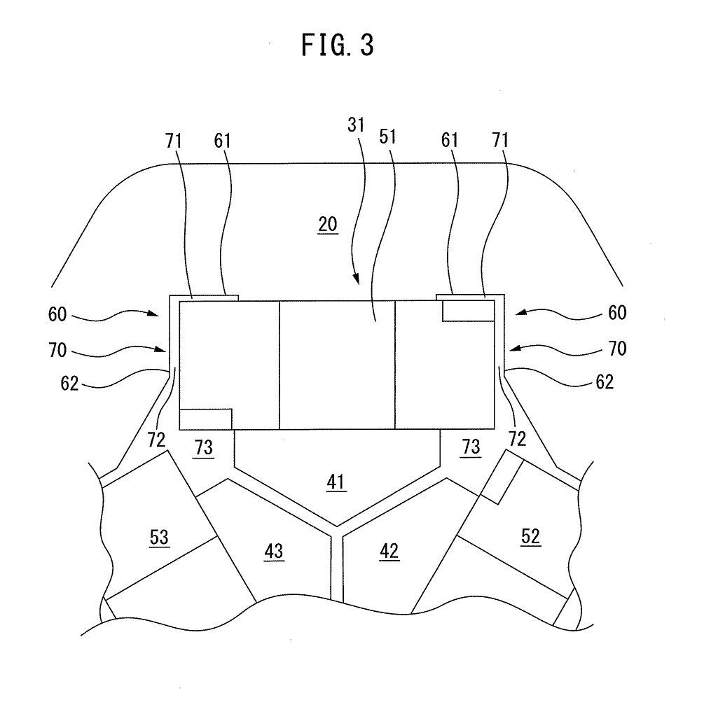

FIG. 3 is a partly enlarged view of the reactor shown in FIG. 2. As shown in FIG. 3, the notch 60 includes a first portion 61 that is concave outside in the radial direction with respect to the inner surface of the outer peripheral iron core 20, and a second portion 62 that is perpendicular to the first portion 61. The first portion 61 of the notch 60 faces an end face of the coil 51, while the second portion 62 of the notch 60 faces a periphery of the coil 51.

Spaces 70 are formed between the outer peripheral iron core 20 and the coil 51 in positions corresponding to the notches 60. The space 70 includes a first space 71 formed between the first portion 61 of the notch 60 and the end face of the coil 51, and a second space 72 formed between the second portion 62 of the notch 60 and the periphery of the coil 51. In other words, by forming a single notch 60, the first space 71 and the second space 72 can be easily formed. Furthermore, the space 70 further includes a third space 73 formed between the adjacent two iron cores 41 and 42 and the outer peripheral iron core 20. To be more specific, the third space 73 is an area enclosed by the adjacent two iron cores 41 and 42, the outer peripheral iron core 20 and the coils 51 and 52. The third space 73 further enhances the cooling effect. Note that, notches 60 and spaces 70 formed by the other iron cores 42 and 43 are the same as the above, so a description thereof is omitted.

As described above, according to the first embodiment, the spaces 70 formed between each of the coils 51 to 53 and the outer peripheral iron core 20 enhance the cooling effect and prevent an increase in the temperature of the coils 51 to 53. Furthermore, the gaps 101 to 103 formed at the center of the reactor 5 further increases the cooling effect.

Therefore, the reactor 5 can eliminate the need for providing a reactor case and a coolant cooling device, thus reducing the size and manufacturing cost of the reactor 5. Furthermore, the notches 60 formed in the outer peripheral iron core 20 contribute to a reduction in the weight of the reactor 5.

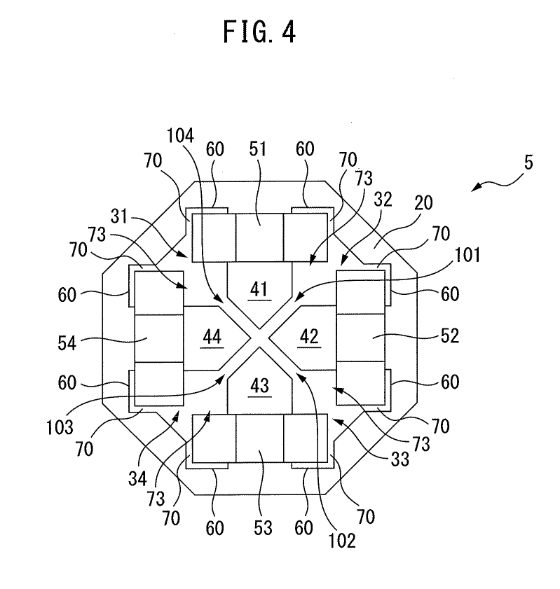

FIG. 4 is an end face view of a reactor according to a second embodiment. A reactor 5 shown in FIG. 4 includes an outer peripheral iron core 20 and four iron-core coils 31 to 34 that are magnetically connected to the outer peripheral iron core 20. The number of the iron-core coils is preferably an even number of 4 or more, and the reactor 5 can be thereby used as a single-phase reactor.

In FIG. 4, the iron-core coils 31 to 34 are arranged inside the octagonal outer peripheral iron core 20. Note that, the outer peripheral iron core 20 may be round in shape. The iron-core coils 31 to 34 are arranged at approximately equal intervals in a circumferential direction of the reactor 5.

As is apparent from the drawing, the iron-core coils 31 to 34 include iron cores 41 to 44 extending in a radial direction and coils 51 to 54 wound onto the iron cores 41 to 44, respectively. Each of the iron cores 41 to 44 contacts the outer peripheral iron core 20 or is formed integrally with the outer peripheral iron core 20 at its radial outer end portion.

Furthermore, a radial inner end portion of each of the iron cores 41 to 44 is situated in the vicinity of the center of the outer peripheral iron core 20. In FIG. 4, the iron cores 41 to 44 converge at the center of the outer peripheral iron core 20 at their radial inner end portions each having an edge angle of approximately 90°. The radial inner end portions of the iron cores 41 to 44 are separated from each other by gaps 101 to 104, which can be magnetically coupled.

In other words, in the second embodiment, the radial inner end portion of the iron core 41 is separated from the radial inner end portions of the adjacent two iron cores 42 and 44 by the gaps 101 and 104, respectively. The same is true for the other iron cores 42 to 44. Note that, the gaps 101 to 104 have approximately the same dimensions as each other.

Therefore, a single approximately X-shaped gap, which is constituted of the gaps 101 to 104, is formed at the center of the reactor 5. The gaps 101 to 104 are arranged at equal intervals in the circumferential direction of the reactor 5. According to the second embodiment, since the outer peripheral iron core 20 encloses the four iron-core coils 31 to 34, the outer peripheral iron core 20 prevents leakage of magnetic fields generated by the coils 51 to 54 to the outside.

Furthermore, as in the case of the first embodiment, approximately triangular notches 60 are formed in the inner surface of the outer peripheral iron core 20 on both sides of radial outer end portions of the iron-core coils 31 to 34. The notches 60 include a first portion 61 that is concave outside in a radial direction with respect to the inner surface of the outer peripheral iron core 20, and a second portion 62 that is perpendicular to the first portion 61.

Spaces 70 are formed between the outer peripheral iron core 20 and each of the coils 51 to 54 in positions corresponding to the notches 60. In the second embodiment, as in the case of FIG. 3, the space 70 includes a first space 71 formed between the first portion 61 of the notch 60 and an end face of each of the coils 51 to 54, and a second space 72 formed between the second portion 62 of the notch 60 and the periphery of each of the coils 51 to 54. Therefore, the single-phase reactor 5 shown in FIG. 4 can have the same effect as the first embodiment.

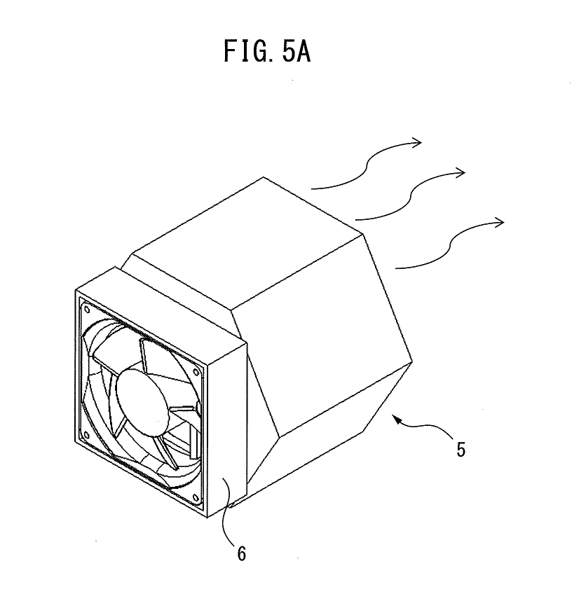

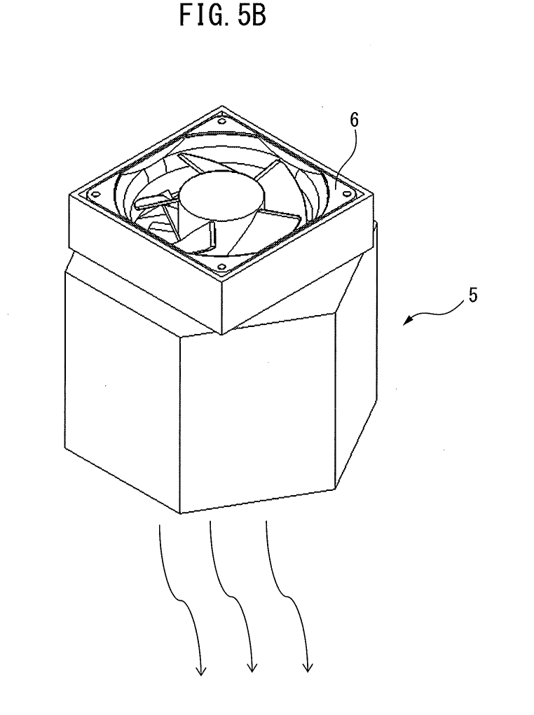

A reactor 5 described below may be any of a three-phase reactor and a single-phase reactor. FIGS. 5A and 5B are perspective views of a reactor according to a third embodiment. In FIG. 5A, a reactor 5 is disposed such that its axial direction coincides with the horizontal direction. In FIG. 5B, the reactor 5 is disposed such that its axial direction coincides with the vertical direction. In the drawings, a cooling fan 6 is attached to an end face of the reactor 5. The cooling fan 6 is driven by a non-illustrated motor.

When the cooling fan 6 is driven, air flows from the cooling fan 6 through spaces 70 and/or gaps 101 to 104 of the reactor 5 in the axial direction of the reactor 5. Therefore, the cooling effect on the coils 51 to 54 of the reactor 5 is further enhanced.

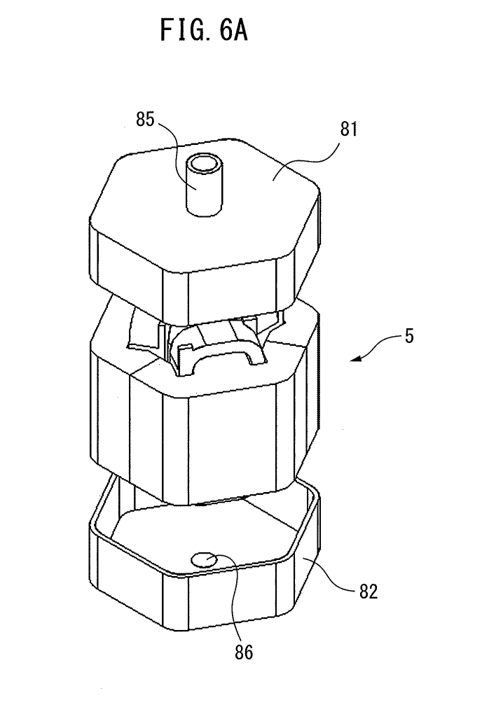

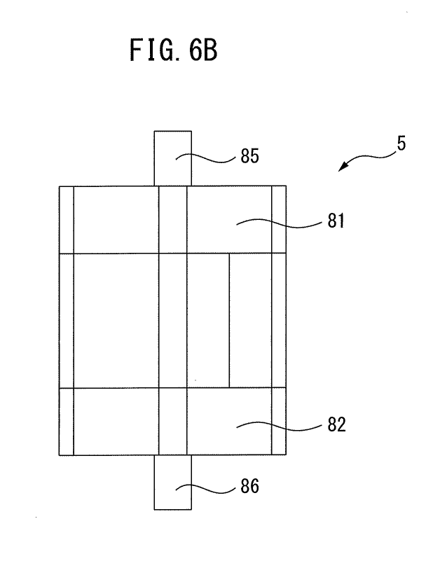

FIG. 6A is an exploded perspective view of a reactor according to a fourth embodiment, and FIG. 6B is a side view of the reactor according to the fourth embodiment. As shown in the drawings, end plates 81 and 82 are fitted on both ends of a reactor 5. The end plates 81 and 82 function as lids for air-tightly sealing the end portions of the reactor 5. Note that, the end plates 81 and 82 may be made of the same material as an outer peripheral iron core 20, or may be made of another material, e.g., a resin.

Through holes 85 and 86 are formed in the end plates 81 and 82, respectively. The through hole 85 of the end plate 81 is connected to a coolant tube that extends from a non-illustrated coolant cooling device. When the end plates 81 and 82 close the both ends of the reactor 5, the through hole 85 of the end plate 81 and the through hole 86 of the other end plate 82 are connected to each other through spaces 70 and/or gaps 101 to 104.

A coolant cooled by the coolant cooling device is supplied to the through hole 85 of the end plate 81 through the coolant tube, and reaches the reactor 5 through the through hole 85. After that, the coolant flows through the spaces 70 and/or the gaps 101 to 104 of the reactor 5 in the axial direction of the reactor 5. The coolant reaches the through hole 86 of the end plate 82, and is ejected from the end plate 82.

In this case, since the end plates 81 and 82 having the through holes 85 and 86 formed therein are fitted on the both ends of the reactor 5, it is possible for the coolant to easily flow through the reactor 5. This further enhances the cooling effect. Furthermore, this embodiment requires only disposing the end plates 81 and 82, and therefore allows a reduction in the dimensions of the reactor 5, especially the diameter of the reactor 5, as compared with using a reactor case.

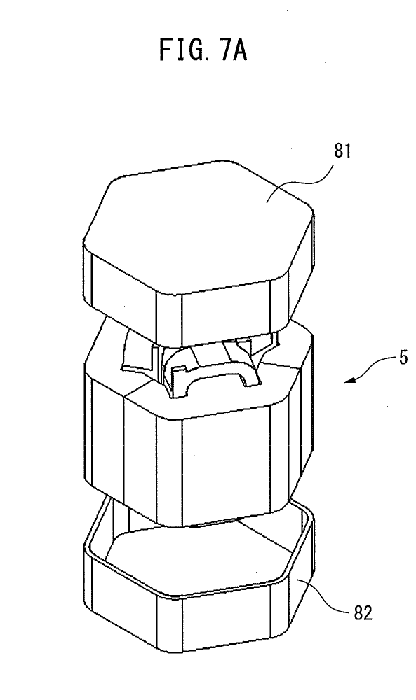

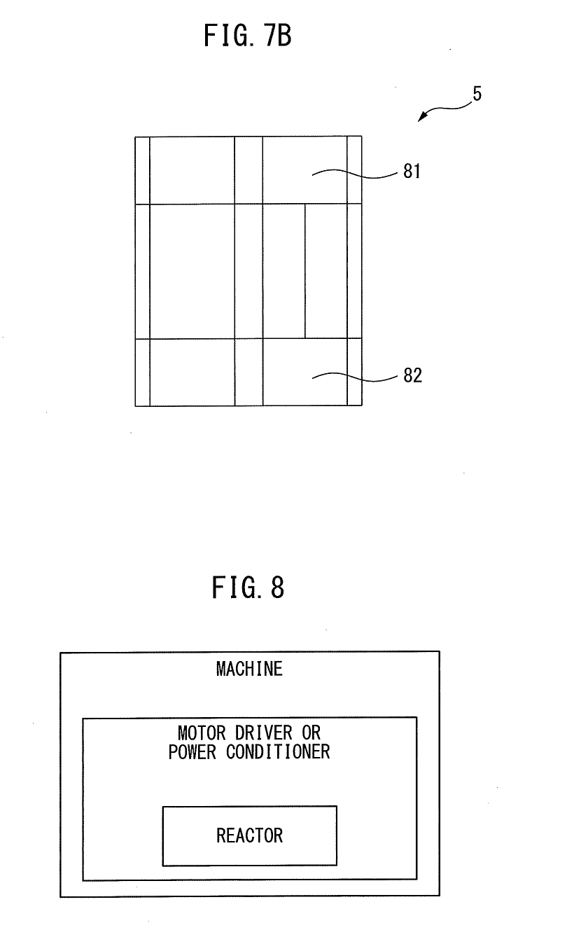

FIG. 7A is an exploded perspective view of a reactor according to a fifth embodiment, and FIG. 7B is a side view of the reactor according to the fifth embodiment. As shown in the drawings, end plates 81 and 82, which are similar to the above, are fitted on both ends of a reactor 5. However, no through hole is formed in the end plates 81 and 82 according to the fifth embodiment. Since the reactor 5 has an outer peripheral iron core 20, when the end plates 81 and 82 close both ends of the reactor 5, the inside of the reactor 5 is completely sealed in an air tight manner.

In the fifth embodiment, the one end plate 81 is fitted onto one end portion. After that, a coolant is injected from the other end portion of the reactor into spaces 70 and/or gaps 101 to 104. After a predetermined amount of coolant is injected, the other end plate 82 closes the other end portion of the reactor 5.

As described above, according to the fifth embodiment, the coolant can be easily sealed in the reactor 5 merely by fitting the end plates 81 and 82 on the both ends of the reactor 5. This embodiment requires only disposing the end plates 81 and 82, and therefore allows a reduction in the dimensions of the reactor 5, especially the diameter of the reactor 5, as compared with using a reactor case.

FIG. 8 is a block diagram of a machine having a reactor. In FIG. 8, a reactor 5 is used in a motor driver or a power conditioner. The motor driver or the power conditioner is installed in the machine.

In this case, the motor driver, the power conditioner, the machine, etc., having the reactor 5 can be easily provided. The scope of the present invention includes combinations of some of the embodiments described above in an appropriate manner.

Aspects of Disclosure

A first aspect provides a reactor that includes an outer peripheral iron core (20); at least three iron-core coils (31-33) contacting or being connected to an inner surface of the outer peripheral iron core, each of the iron-core coils including iron cores (41-43) and coils (51-53) wound onto the iron cores; and spaces (70) formed between each of the coils and the outer peripheral iron core.

According to a second aspect, the reactor of the first aspect wherein gaps (101-103), which are magnetically coupled, are formed between one of the iron-core coils and the iron-core coil adjacent to the one of the iron-core coils.

According to a third aspect, in the first or second aspect, the number of the iron-core coils is an integer multiple of 3.

According to a fourth aspect, in the first or second aspect, the number of the iron-core coils is an even number of 4 or more.

According to a fifth aspect, in any of the first to fourth aspects, notches (60) are formed in the inner surface of the outer peripheral iron core, and the space includes a first space (71) formed between an end face of the coil and the inner surface of the outer peripheral iron core, and a second space (72) formed between a periphery of the coil and the notch of the outer peripheral iron core.

According to a sixth aspect, in any of the first to fifth aspects, the space includes a third space (73) formed between the two adjacent iron cores and the outer peripheral iron core.

According to a seventh aspect, in any of the first to sixth aspects, a cooling fan (6) is disposed at one end of the reactor.

According to an eighth aspect, in any of the first to sixth aspects, end plates (81 and 82) having through holes (85 and 86) formed therein are fitted on both ends of the reactor, and a coolant flows from the through hole of one of the end plates through the space to the through hole of the other end plate.

According to a ninth aspect, in any of the first to sixth aspects, end plates (81, 82) are fitted on both ends of the reactor, and the space of the reactor is filled with a coolant.

A tenth aspect provides a motor driver that includes the reactor according to any of the first to ninth aspects.

An eleventh aspect provides a machine including the motor driver according to the tenth aspect.

A twelfth aspect provides a power conditioner that includes the reactor according to any of the first to ninth aspects.

A thirteenth aspect provides a machine including the power conditioner according to the twelfth aspect.

Effects of Aspects

According to the first aspect, the space formed between each of the coils and the outer peripheral iron core enhances the cooling effect and prevents an increase in the temperature of the coils. Furthermore, eliminating the need for providing a reactor case and a coolant cooling device reduces the size and manufacturing cost of the reactor.

According to the second aspect, the gaps formed inside the outer peripheral iron core further enhance the cooling effect.

According to the third aspect, the reactor can be used as a three-phase reactor.

According to the fourth aspect, the reactor can be used as a single-phase reactor.

According to the fifth aspect, the notch formed in the outer peripheral iron core contributes to a reduction in the weight of the reactor. The notch facilitates easily forming the space on the end face and the periphery of the coil.

According to the sixth aspect, the third space further enhances the cooling effect.

According to the seventh aspect, air flowing from the cooling fan through the spaces of the reactor in an axial direction further enhances the cooling effect.

According to the eighth aspect, the coolant is let flow through the reactor only by fitting the end plates having the through holes formed therein on the both ends of the reactor. This aspect requires only fitting the end plates, and therefore allows a reduction in the size of the reactor, as compared with using a reactor case.

According to the ninth aspect, owing to the presence of the outer peripheral iron core, the coolant is sealed in the reactor by merely fitting the end plates on the both ends of the reactor. This aspect requires only fitting the end plates, and therefore allows a reduction in the size of the reactor, as compared with using a reactor case.

The tenth to thirteenth aspects easily provide the motor driver, the power conditioner and the machine having the reactor.

The present invention is described above using the preferred embodiments, but it is apparent for those skilled in the art that the above-described modifications and other various modifications, omissions and additions can be made without departing from the scope of the present invention.

What is claimed is:

1. A reactor comprising:
an outer peripheral iron core;
at least three iron-core coils contacting or being connected to an inner surface of the outer peripheral iron core,
each of the iron-core coils including iron cores and coils wound onto the iron cores; and
spaces formed between each of the coils and the outer peripheral iron core.

2. The reactor according to claim 1, gaps, which are magnetically coupled, are formed between one of the iron-core coils and the iron-core coil adjacent to the one of the iron-core coils.

3. The reactor according to claim 1, wherein the number of the iron-core coils is an integer multiple of

3.

4. The reactor according to claim 1, wherein the number of the iron-core coils is an even number of 4 or more.

5. The reactor according to claim 1, wherein
notches are formed in the inner surface of the outer peripheral iron core, and
the space includes a first space formed between an end face of the coil and the inner surface of the outer peripheral iron core, and a second space formed between a periphery of the coil and the notch of the outer peripheral iron core.

6. The reactor according to claim 1, wherein the space includes a third space formed between the two adjacent iron cores and the outer peripheral iron core.

7. The reactor according to claim 1, wherein a cooling fan is disposed at one end of the reactor.

8. The reactor according to claim 1, wherein end plates having through holes formed therein are fitted on both ends of the reactor, and a coolant flows from the through hole of one of the end plates through the space to the through hole of the other end plate.

9. The reactor according to claim 1, wherein end plates are fitted on both ends of the reactor, and the space of the reactor is filled with a coolant.

10. A motor driver comprising the reactor according to claim 1.

11. A machine comprising the motor driver according to claim 10.

12. A power conditioner comprising the reactor according to claim 1.

13. A machine comprising the power conditioner according to claim 12.
